(19) United States
(12) Patent Application Publication
(10) Pub. No.: US 2015/0373003 A1
(43) Pub. Date: Dec. 24, 2015

(54) SIMPLE IMAGE LOCK AND KEY

(71) Applicant: Hyperlayer, Inc., Portland, OR (US)

(72) Inventors: Dan Lipert, Portland, OR (US); Laura Andrews, Portland, OR (US); William Weinstein, Portland, OR (US)

(21) Appl. No.: 14/746,791

(22) Filed: Jun. 22, 2015

Related U.S. Application Data
(60) Provisional application No. 62/015,740, filed on Jun. 23, 2014.

(51) Int. Cl. H04L 29/06; G06K 9/62; H04L 29/08

(52) U.S. Cl. CPC H04L 63/08; H04L 67/06; G06K 9/6202

(57) ABSTRACT

A system for and method of securely controlling access to files on a server are disclosed herein. The method may include receiving an upload of a file to the server, receiving an upload of a first image of an object, using computer vision algorithms to extract first information about the object from the first image, associating the first information with the file, and restricting access to the file. The method may further include receiving an upload of a second image of the object, using the computer vision algorithms to extract second information about the object from the second image, determining that the second information and the first information match within a threshold, and providing access to the file.

### CROSS-REFERENCE TO RELATED APPLICATIONS

This application claims the benefit of U.S. Provisional Patent Application No. 62/015,740, filed Jun. 23, 2014, and entitled “Simple Image Lock and Key”, the complete contents of which are hereby incorporated herein by reference for all purposes.

### BACKGROUND

Many file hosting websites allow users to upload files to a server, then generate a link to the file that the user may use or give to another user to download the file later. For added security, some of these websites include password protection. However, passwords can be cracked, especially if the link to the file is already known. As a result, many file hosting sites unfortunately still suffer from security breaches.

Another technology for assisting users to access online data is two-dimensional barcodes such as Quick Response Codes (QR Code®). These are used to hold a small amount of data, which for example can represent a web address at which additional information on a product may be located. However, one drawback with QR codes is that they take up valuable real estate on product packaging and are unintelligible to the human eye. As a result, particularly for those users who do not utilize the QR codes, they represent nothing more than visual noise.

As a result, the process of uploading, sharing, and retrieving information is still a disjointed one for many users.

### SUMMARY

A system for and method of securely controlling access to files on a server are disclosed herein. The method may include receiving an upload of a file to the server, receiving an upload of a first image of an object, using computer vision algorithms to extract first information about the object from the first image, associating the first information with the file, and restricting access to the file. The method may further include receiving an upload of a second image of the object, using the computer vision algorithms to extract second information about the object from the second image, determining that the second information and the first information match within a threshold, and providing access to the file.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of a computing system for securely controlling access to files.

FIG. 2A shows a computing device uploading a file and first image to a server.

FIG. 2B shows another computing device uploading a second image to the server.

FIG. 2C shows the other computing device downloading the file from the server.

FIG. 3 illustrates a flowchart of a method of securely controlling access to files on a server.

FIG. 4 shows a simplified schematic view of an example computing system.

### DETAILED DESCRIPTION

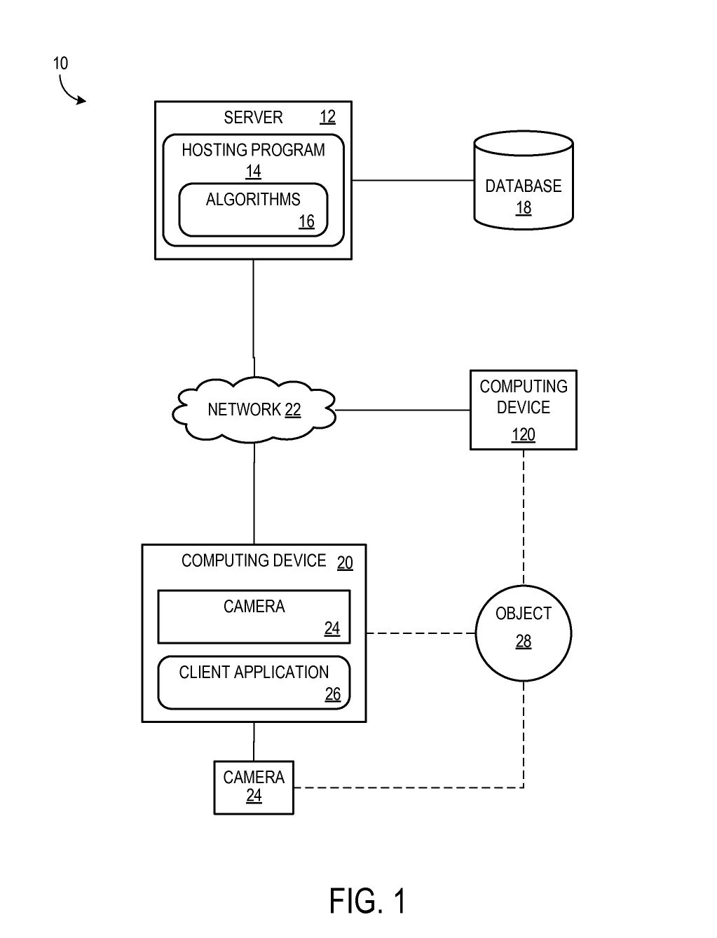

Accordingly, a system for securely controlling access to files on a server is described with reference to FIG. 1. FIG. 1 shows a schematic view of a computing system 10 for securely controlling access to files. The computing system 10 may include a server 12 configured to execute a hosting program 14 to coordinate secure file transfers to and from the server 12. The hosting program 14 may use algorithms 16, which may include various computer vision algorithms and optional encryption algorithms. The server 12 may be connected to a database 18 for storing files and information.

The server 12 may be connected to a computing device 20 through a network 22. The computing device 20 may be a personal computer, smartphone, tablet, etc. The computing device 20 may include a camera 24 for capturing images or video. Alternatively, the camera 24 may be external to the computing device 20 and provide the captured images or video to the computing device 20 via any suitable connection. The computing device 20 may be configured to execute a client application 26 associated with the hosting program 14. The server 12 may also be connected through the network 22 to another computing device 120, similar to the computing device 20. While only one computing device 120 is pictured, it will be understood that any number of other computing devices 120 (e.g., a third computing device, a fourth computing device, etc.) may connect to the server 12. Any camera 24, whether in the computing device 20, in the computing device 120, or external to both, may be configured to capture images of an object 28. The object 28 may be a real world object such as a rock in a user's front yard, a drawing on a piece of paper, or a person's face, for example. The object 28 may even be a particular scene, for instance a view of a city from a specific vantage point. The object 28 may be two- or three-dimensional. The object 28 may also be a digital object such as an advertisement displayed on a display screen.

The computer vision algorithms of the algorithms 16 may include any combination of, but are not limited to, feature extraction algorithms, classification algorithms, and analysis algorithms. The feature extraction algorithms may include Binary Robust Independent Elementary Features (BRIEF), Oriented-BRIEF (ORB), Speeded Up Robust Features (SURF), Scale-Invariant Feature Transform (SIFT), Histogram of Oriented Gradients (HOG), corner detectors, etc. The classification algorithms may include k-Nearest Neighbor (k-NN), Support Vector Machine (SVM), Haar Classifiers, Geolocation, Geofences, non-Euclidean distance calculations, etc. The analysis algorithms may include Bag-of-Words, tokenization, MinHash, Perceptual Hash, term frequency weighting, document frequency weighting, etc. Many other suitable algorithms may also be used.

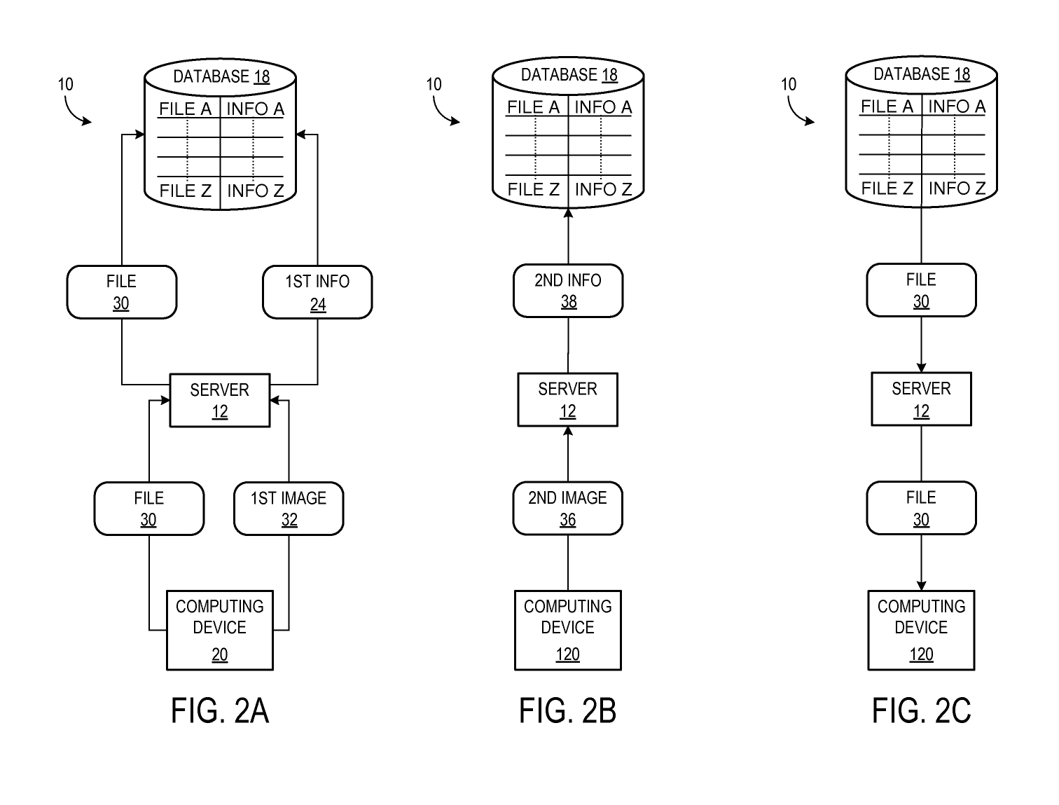

Operation of the client application 26 and hosting program 14 is described with reference to FIGS. 2A-2C. FIG. 2A shows the computing device 20 uploading a file 30 and first image 32 to the server to be stored in the database 18. The file 30 may be any conceivable type of file, for example a video, document, or audio file, a collection of multiple files, or other type of collected data. The file 30 may also be a string of text, a link, or a private key or password, for example. The first image 32 may be an image of object 28 captured by camera 24 of FIG. 1, and the user may have the option of indicating which portion of the first image 32 contains the object 28. The server 12 may be configured to execute the hosting program 14 of FIG. 1 and use the computer vision algorithms to extract first information 34 about the object 28 from the first image 32. The first information 34 may not be information about the specific first image 32, but rather, about the object 28 itself such that an image of the object 28 captured from any angle may be used to extract the same first information 34.

The server 12 may be configured to associate the first information 34 with the file 30 and store them both in the database 18. The database 18 may hold numerous files with corresponding information. At this point, the server 12 may restrict access to the file 30. In this manner, the file 30 is inaccessible from the server 12 and may be considered “locked.” Optionally, the server 12 may be configured to use the first information 34 as a feed in one or more of the encryption algorithms to encrypt the file 30. Alternatively, the client application 26 of FIG. 1 may be configured to encrypt the file 30 such that the file 30 is not decryptable while stored in the database 18. With such a configuration, the server 12 may have no way of discerning what files are stored in the database 18. As another option, the user's current location, for instance as sensed by a global positioning sensor, may be uploaded to further restrict access by physical location, and may be included with the first image 32 as metadata.

Another user may request access to the file 30 in one implementation. For instance, a link to the file 30 may be generated once it is uploaded to the server 12, and the other user may request to access the file 30 via the link. However, even with the optional link, the file 30 is still “locked” on the server 12. FIG. 2B shows another computing device 120 uploading a second image 36 to the server 12 in order to “unlock” the file 30 of FIG. 2A. Thus, the second image 36 may be considered a “key.” The first image 32 and/or the second image 36 may be one or more frames from one or more videos rather than an individual image. The second image 36 may be of the same object 28 as the first image 32, and may be the same image if so desired. The server 12 may be configured to use the computer vision algorithms to extract second information 38 about the object 28 from the second image 36. If the file 30 is restricted by physical location, the other user's location may be confirmed to be the same as the first user's within a threshold before the file 30 may be “unlocked.”

FIG. 2C shows the other computing device 120 downloading the file 30 from the server 12. The computing device 120 may be the computing device 20, for instance if the user wished to store a file 30 for his own use rather than to send to another user, but it may also be a separate device. The server 12 may be configured to determine whether the second information 38 and the first information 34 match within a threshold. If they match, then the server 12 may be configured to provide access to the file 30, “unlocking” the file 30. Without a match, the server 12 may be configured to continue restricting access to the file 30. In this manner, the security of the file 30 may be tied to the objects present in a specific real world location chosen by the user of the computing device 20. Matching between the first information 34 and second information 38 may be weighted by a variety of factors. One such factor may be geofencing data included with the information 34, 38. In this manner, whether the first image 32 and the second image 36 were captured at the same or nearby locations may be one factor to increase the likelihood of determining a match, but the server 12 may also be configured to determine a match without the factor, for instance, if the second image 36 does not have an associated location.

In some cases, when the second image 36 is determined to have a high threshold of similarity with the first image 32 that is above a predetermined threshold, the second image 36 may be enrolled with the hosting program 14 as another source image like the first image 32. The second image 36 may be of the same object 28 but captured from a different position and orientation. Adding the second image 36 as a second source image may allow both the first information 34 and the second information 38 to be used for comparison with information extracted from any future image (e.g., a third image) submitted in an attempt to unlock the file 30. This may increase the accuracy of any such comparison.

The system described above has many potential implementations. In one implementation, the object may be a logo. The logo may be on a sticker or business card, for instance as part of an advertising campaign. The system may provide the function of a two-dimensional barcode with the added benefit of showing the user what to expect, via the logo, without needing extra space for the barcode itself. If the object is a business card, the file may link to a company website or it may be a resume, for example. The object may also be a picture, poster, cover, etc. For instance, an album cover for a new album could be the “key” to “unlock” a preview of the album, or a movie poster could “unlock” a trailer for the movie.

In another implementation, the object may be one of a plurality of objects, images of which may correspond to a plurality of files. The system may be configured to generate a map of the plurality of objects. The files may still be secure, but perhaps the user trying to access the file does not know or does not remember which object may be used to create the “key.” Such a map may also be used for a scavenger hunt type of activity. In yet another implementation, the system could be “unlocked” to grant the user access to an account, rather than to a specific file that the user wants, for instance as part of a two-factor authentication process. In still another implementation, the “key” is used to grant access to an entire data store of the database rather than one particular file. For instance, a user's entire hard drive may be securely backed up online.

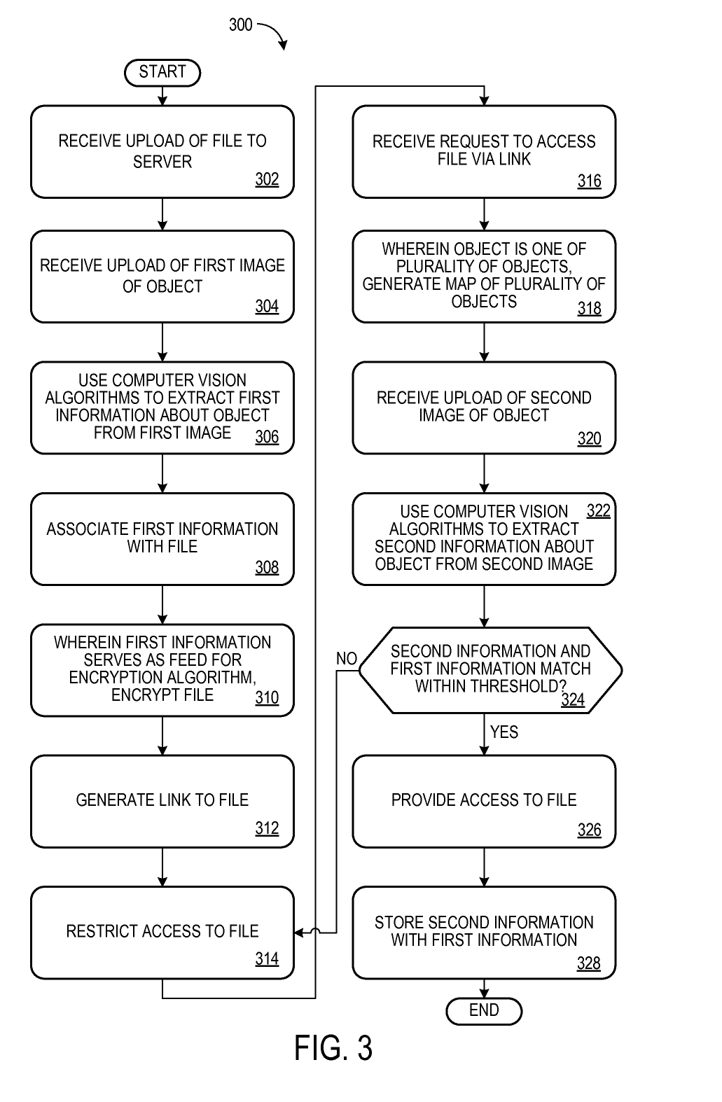

FIG. 3 illustrates a flowchart of a method 300 of securely controlling access to files on a server. The following description of method 300 is provided with reference to the software and hardware components of the computing system 10 described above and shown in FIGS. 1 and 2A-C. It will be appreciated that method 300 may also be performed in other contexts using other suitable hardware and software components.

With reference to FIG. 3, at 302 the method 300 may include receiving an upload of a file to the server. At 304 the method 300 may include receiving an upload of a first image of an object. At 306 the method 300 may include using computer vision algorithms to extract first information about the object from the first image. At 308 the method 300 may include associating the first information with the file. At 310 the method 300 may optionally include wherein the first information serves as a feed for an encryption algorithm, encrypting the file. At 312 the method 300 may optionally include generating a link to the file.

At 314 the method 300 may include restricting access to the file. At 316 the method 300 may optionally include receiving a request to access the file via the link. At 318 the method 300 may optionally include wherein the object is one of a plurality of objects, the method further comprising generating a map of the plurality of objects. As another option, the object may be a logo.

At 320 the method 300 may include receiving an upload of a second image of the object. At 322 the method 300 may include using the computer vision algorithms to extract second information about the object from the second image. At 324 the method 300 may include determining whether the second information and the first information match within a threshold. If NO at 324, the method 300 may include returning to 314 (restricting access to the file). If YES at 324, the method 300 may include proceeding to 326, providing access to the file. At 328, the method 300 may include storing the second information with the first information so that the second information may also be used when comparing future submitted images to determine a match, e.g., for a comparison with information extracted from a third image.

A system and method for securely controlling access to files on a server are described above. The system compares information extracted from two images to determine whether the images are of the same object before granting access to a file stored on the server. This approach has the potential advantage of preventing virtual theft by tying security to a physical location with real world objects present. Additionally, the system has various other uses including marketing strategies.

In some embodiments, the methods and processes described herein may be tied to a computing system of one or more computing devices. In particular, such methods and processes may be implemented as a computer-application program or service, an application-programming interface (API), a library, and/or other computer-program product.

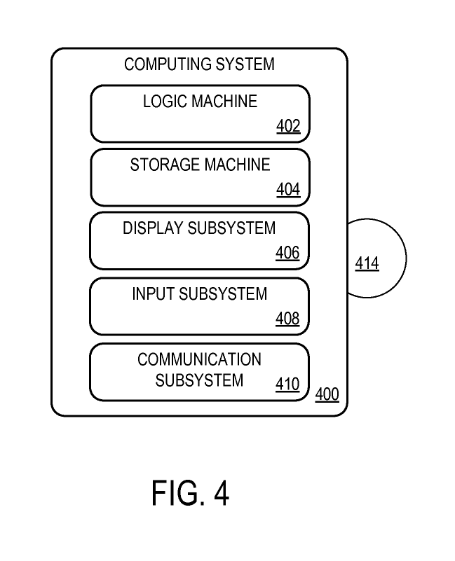

FIG. 4 schematically shows a non-limiting embodiment of a computing system 400 that can enact one or more of the methods and processes described above. Computing system 10 may be one example of computing system 400. Computing system 400 is shown in simplified form. Computing system 400 may take the form of one or more personal computers, server computers, tablet computers, home-entertainment computers, network computing devices, gaming devices, mobile computing devices, mobile communication devices (e.g., smartphone), and/or other computing devices.

Computing system 400 includes a logic machine 402 and a storage machine 404. Computing system 400 may optionally include a display subsystem 406, input subsystem 408, communication subsystem 410, and/or other components not shown in FIG. 4.

Logic machine 402 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 404 includes one or more physical devices configured to hold instructions executable by the logic machine to implement the methods and processes described herein. When such methods and processes are implemented, the state of storage machine 404 may be transformed—e.g., to hold different data.

Storage machine 404 may include removable and/or built-in devices 414. Storage machine 404 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 404 may include volatile, nonvolatile, dynamic, static, read/write, read-only, random-access, sequential-access, location-addressable, file-addressable, and/or content-addressable devices.

It will be appreciated that storage machine 404 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 402 and storage machine 404 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 400 implemented to perform a particular function. In some cases, a module, program, or engine may be instantiated via logic machine 402 executing instructions held by storage machine 404. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across multiple user sessions. A service may be available to one or more system components, programs, and/or other services. In some implementations, a service may run on one or more server-computing devices.

When included, display subsystem 406 may be used to present a visual representation of data held by storage machine 404. This visual representation may take the form of a graphical user interface (GUI). As the herein described methods and processes change the data held by the storage machine, and thus transform the state of the storage machine, the state of display subsystem 406 may likewise be transformed to visually represent changes in the underlying data. Display subsystem 406 may include one or more display devices utilizing virtually any type of technology. Such display devices may be combined with logic machine 402 and/or storage machine 404 in a shared enclosure, or such display devices may be peripheral display devices.

When included, input subsystem 408 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 410 may be configured to communicatively couple computing system 400 with one or more other computing devices. Communication subsystem 410 may include wired and/or wireless communication devices compatible with one or more different communication protocols. As non-limiting examples, the communication subsystem may be configured for communication via a wireless telephone network, or a wired or wireless local- or wide-area network. In some embodiments, the communication subsystem may allow computing system 400 to send and/or receive messages to and/or from other devices via a network such as the Internet.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of securely controlling access to files on a server, the method comprising:
receiving an upload of a file to the server;
receiving an upload of a first image of an object;
using computer vision algorithms to extract first information about the object from the first image;
associating the first information with the file;
restricting access to the file;
receiving an upload of a second image of the object;
using the computer vision algorithms to extract second information about the object from the second image;
determining that the second information and the first information match within a threshold; and
providing access to the file.

2. The method of claim 1, further comprising:
generating a link to the file; and
receiving a request to access the file via the link.

3. The method of claim 1, wherein the object is a logo.

4. The method of claim 1, wherein the first information serves as a feed for an encryption algorithm.

5. The method of claim 1, wherein the object is one of a plurality of objects, the method further comprising generating a map of the plurality of objects.

6. The method of claim 1, further comprising:
storing the second information with the first information for a comparison with third information extracted from a third image.

7. The method of claim 1, wherein at least one of the first image and the second image is a video frame.

8. The method of claim 1, wherein the first image and the second image are captured from different locations.

9. The method of claim 1, wherein a location determined by a global positioning sensor is included with the first image as metadata.

10. A computing system for securely controlling access to files, the system comprising:
a server configured to execute a hosting program to coordinate secure file transfers to and from the server;
a database; and
at least one computing device connected to the server via a network;
wherein the server is configured to:
receive an upload of a file from the computing device and store the file in the database;
receive an upload of a first image of an object from the computing device;
use computer vision algorithms to extract first information about the object from the first image;
associate the first information with the file;
restrict access to the file;
receive an upload of a second image of the object from the computing device or another computing device;
use the computer vision algorithms to extract second information about the object from the second image;
determine that the second information and the first information match within a threshold; and
provide access to the file.

11. The computing system of claim 10, wherein the server is further configured to:
generate a link to the file; and
receive a request to access the file via the link.

12. The computing system of claim 10, wherein the object is a logo.

13. The computing system of claim 10, wherein the first information serves as a feed for an encryption algorithm.

14. The computing system of claim 10, wherein the object is one of a plurality of objects, the server further configured to generate a map of the plurality of objects.

15. The computing system of claim 10, wherein the server is further configured to store the second information with the first information for a comparison with third information extracted from a third image.

16. The computing system of claim 10, wherein at least one of the first image and the second image is a video frame.

17. The computing system of claim 10, wherein the first image and the second image are captured from different locations.

18. The computing system of claim 10, wherein a location determined by a global positioning sensor is included with the first image as metadata.

19. A computing system for securely controlling access to files, the system comprising:
a server configured to execute a hosting program to coordinate secure file transfers to and from the server;
a database; and
first and second computing devices connected to the server via a network;
wherein the server is configured to:
receive an upload of a file from the first computing device and store the file in the database;
receive an upload of a first image of an object from the first computing device, wherein a location determined by a global positioning sensor is included with the first image as metadata;
use computer vision algorithms to extract first information about the object from the first image, wherein the first information serves as a feed for an encryption algorithm;
associate the first information with the file;
restrict access to the file;
receive an upload of a second image of the object from the second computing device;
use the computer vision algorithms to extract second information about the object from the second image;
determine that the second information and the first information match within a threshold; and
provide the second computing device with access to the file.

20. The computing system of claim 19, wherein the server is further configured to:
generate a link to the file; and
receive a request to access the file via the link.
